(19) United States
(12) Patent Application Publication
(10) Pub. No.: US 2021/0336783 A1
(43) Pub. Date: Oct. 28, 2021

(54) METHOD FOR CHECKING THE AUTHENTICITY OF ELECTRONIC MODULES OF A MODULAR FIELD DEVICE IN AUTOMATION TECHNOLOGY

(71) Applicant: Endress+Hauser Conducta GmbH+Co. KG, Gerlingen (DE)

(72) Inventors: Thomas Alber, Stuttgart (DE); Markus Kilian, Merzhauen (DE); Axel Pöschmann, Basel (CH); Sascha Bihler, Rheinfelden (DE); Simon Merklin, Bahlingen a.K. (DE)

(21) Appl. No.: 17/237,371

(22) Filed: Apr. 22, 2021

(30) Foreign Application Priority Data
Apr. 22, 2020 (DE) 10 2020 111 019.7

(51) Int. Cl. H04L 9/30; H04L 9/32

(52) U.S. Cl. CPC H04L 9/30; H04L 9/3247; H04L 9/3271

(57) ABSTRACT

A method for checking the authenticity of electronic modules is disclosed. Each electronic module is assigned a key pair confirming the identity of the electronic module, wherein each key pair consists of a public key and a private key, and wherein the public keys of the key pairs are stored in a list. The list is assigned to the field device, and: when an electronic module is exchanged or added, the field device checks: whether the exchanged or added electronic module has a key pair, and whether the public key of the exchanged or added electronic module is listed in the list of public keys, and whether the electronic module is in possession of the correct private key. Interaction of the changed electronic module with the field device concerning the functionality of the field device is permitted if the check is concluded with a positive result.

### CROSS-REFERENCE TO RELATED APPLICATION

The present application is related to and claims the priority benefit of German Patent Application No. 10 2020 111 019.7, filed on Apr. 22, 2020, the entire contents of which are incorporated herein by reference.

### TECHNICAL FIELD

The present disclosure relates to a method for checking the authenticity of electronic modules of a modular field device in automation technology.

### BACKGROUND

Field devices for detecting and/or influencing physical, chemical, or biological process variables are often used in process automation as well as in manufacturing automation. Measuring devices are used for detecting process variables. These measuring devices are used, for example, for pressure and temperature measurement, conductivity measurement, flow measurement, pH measurement, fill level measurement, etc., and detect the corresponding process variables of pressure, temperature, conductivity, pH value, fill level, flow, etc. Actuator systems are used for influencing process variables. Examples of actuators are pumps or valves that can influence the flow of a fluid in a pipe or the fill level in a tank. In addition to the aforementioned measuring devices and actuators, field devices are also understood to include remote I/O's, radio adapters, or, generally, devices that are arranged at the field level. In connection with the present disclosure, all devices which are used in the vicinity of the process or of the plant and which supply or process the information relevant to process or plant are referred to as field devices.

Corresponding field devices usually consist of a multiplicity of electronic modules, such as plug-in modules with circuit boards, sensors with digital connection, etc. If an electronic module is exchanged or added, then currently no check is made as to whether the electronic module is authentic. Currently, an electronic module is usually visually checked and, after a positive visual inspection, is accepted as authentic.

The procedure described above poses a considerable safety risk: Since, in principle, there is no possibility of detecting an electronic module of any kind whatsoever which may have been tampered with, there is the risk that an electronic module which may have been tampered with will be installed in an installation of automation technology. If, for example, the electronic module does not meet the requirements for use in a potentially explosive area but is used in such an area, this can absolutely have life-threatening effects.

The present patent application describes a method for ensuring module authenticity: Is the module in fact the module that it pretends to be. The primary concern here is to check whether a specific module is present, wherein here the identity is checked and modules of the same design are not automatically accepted. In a patent application of the applicant filed in parallel with this patent application, the manufacturer authenticity is checked, i.e., whether an electronic module originates from an original manufacturer or from a trustworthy third party or a supplier. Of course, both methods could also be used simultaneously or sequentially for checking an electronic module.

### SUMMARY

The object of the present disclosure is to automatically detect a non-authentic electronic module.

The object is achieved by a method for checking the authenticity of electronic modules of a modular field device of automation technology, wherein each electronic module of the field device is assigned a suitable key pair which confirms the identity of the electronic module, wherein each key pair consists of a public key Pk and a private key pk, and wherein the public keys of the suitable key pairs are stored in a list, wherein the list is assigned to the field device or to a unit communicating with the field device, wherein the method comprises the following method steps: when an electronic module is exchanged or added, the field device or the unit communicating with the field device checks: whether the exchanged or added electronic module has a key pair, and whether the public key of the exchanged or added electronic module is listed in the list of public keys, whether the electronic module is in possession of the correct private key; and communication or interaction of the exchanged or added electronic module with the field device or some other electronic module concerning the functionality of the field device is permitted if the check is concluded with a positive result.

A check is thus made as to whether those individual modules that should be present according to the module trust list are present. If an electronic module is replaced or added, this is detected with the method according to the present disclosure. Integration into the operation is denied if the electronic module cannot prove its authenticity.

According to the present disclosure, before a field device incorporates an exchanged or added electronic module into the communication required for operating the field device, the field device thus checks whether the public key of the electronic module is contained in the list of electronic modules identified as trustworthy. The authenticity of an electronic module is usually checked during the run time of the field device.

The key pair assigned to each electronic module is also referred to as the cryptographic identity of the electronic module. Symmetric encryption and asymmetric encryption are known in principle. While encryption and decryption occur with an identical key in the case of symmetric encryption, they occur with two different keys in the case of asymmetric encryption.

In asymmetric cryptography, RSA-based key pairs, which may differ in key length, are often used. Currently, RSA keys of length 2048 bits are already considered critical; whoever requires more security uses key lengths of 3072 or even 4096 bits. However, not only do the increasing key lengths have a negative effect on the required memory space, but the performance also suffers, namely both in the case of asymmetric encryption and decryption and, above all, in key pair generation. Significantly more efficient than the RSA cryptographic systems based on prime number bodies are those using elliptic curves. A few EC (elliptic curves) have become established. One of them is Curve25519.

Preferably, an asymmetric key pair is used in connection with the present disclosure. The asymmetric encryption methods are considered to be very secure since two keys that cannot be derived from one another are used: a public key for encryption and a private key for decryption, or vice versa. The private key always remains with the generator of the key. Either encryption is done with the private key and decryption with the public key, or vice versa.

The following method step is furthermore proposed: in order to check whether the electronic module is in possession of the public key of the suitable key pair, the field device or the unit communicating with the field device requests the public key of the exchanged or added electronic module and checks whether the public key of the electronic module is stored in the list of public keys classified as trustworthy.

In addition, the test is performed as to whether the electronic module is in possession of the private key of the suitable key pair. A challenge/response method is preferably used for this test. The fact that an electronic module delivers a trustworthy public key does not yet prove that it is also the public key associated with this electronic module. Ultimately, it could also be a fake module using an illegitimately acquired public key. There must therefore be a check of whether this electronic module is authentic, i.e., whether the supplied public key also actually belongs to this electronic module, whether the electronic module has supplied the correct public key associated with it, and whether it can also prove this. As stated, the challenge/response method is preferably used for this proof.

For this purpose, the field device or an electronic component sends an arbitrary message to the exchanged or added electronic module with the request for signature creation (“challenge”). The module signs this message and transmits the signature (“response”) back to the field device or back to the requesting electronic module. The field device or the requesting electronic module can now check based on the signature whether the electronic module is in possession of the correct private key.

The signature is created by way of example as follows: The module k applies a hash method to the message m and encrypts the hash value obtained with its private key. The field device decrypts the obtained signature with the public key of the module and compares it to a self-calculated hash value of the transmitted message. Ideally, both hash values are identical, which proves a) that the module said the truth since it has sent the correct public key and b) that it can also prove this since it possesses the associated private key. With the provision of this proof, the exchanged or added electronic module is considered authentic. For signature creation, special algorithms (DSA ECDSA, etc.) have also become known, which ultimately however also work with an asymmetric key pair.

If an electronic module now has no suitable key pair or only one based on a different curve or on a different cryptographic system, it cannot participate in the challenge/response method. A remedy is possible if this electronic module has a generator by means of which such a suitable key pair can be generated; alternatively, it must have a corresponding interface and a key memory so that an externally generated key pair may be subsequently written into the electronic module. In both cases, however, the module has to know the applicable/associated operations, e.g., encrypting with the private key.

In summary, an arbitrary message is sent to the exchanged or added electronic module, from the field device, as a challenge with the request for signature creation using the private key. The electronic module signs the message with its private key and returns the signature as a response. The signature is used to check whether the electronic module is in possession of the private key of the suitable key pair. Any key pair, in terms of asymmetric cryptography, is to be considered suitable. RSA-based or EC-based key pairs are common. A key pair is a tool. Such a key pair is now used by the field device to determine the authenticity of the electronic module.

“Suitable” can be further restricted in the specific case: Both the field device and the electronic module must know the respective operations (encryption, decryption) with the key pair. For example, if the field device knows, for example, only EC and the module only RSA, the present disclosure will not work. If the electronic module has no asymmetric cryptography at all, there is also no suitable key pair.

Some special cases are described below: If the check shows that the exchanged or added electronic module has no key pair, a check is made as to whether a key pair for the electronic module can be generated or provided, wherein in the event that the key pair is provided or generated by another electronic module, the key pair is transferred to the exchanged or added electronic module.

Furthermore, it is proposed in connection with the present disclosure that an exchanged or added electronic module which has no suitable key pair or for which no suitable key pair can be generated remains excluded from the communication.

If the check shows that the exchanged or added electronic module has a key pair, but that the public key of the key pair is not stored in the list even though the electronic module seems authentic, the public key of the generated key pair is assigned to the list of electronic modules classified as trustworthy once an authorized person has confirmed the trustworthiness of the electronic module.

In the case where a suitable key pair can be generated for the electronic module, the public key of the key pair is also stored in the list of electronic modules classified as trustworthy if an authorized person confirms the trustworthiness of the electronic module. In this way, the list can get larger and contain the public keys of a plurality of electronic modules. Of course, when a module is exchanged, it is expedient to remove the public key of the exchanged module from the module trust list.

If an electronic module has no suitable key pair or only one that is based on another curve or on another cryptographic system, it cannot participate in the challenge/response method. In order to generate a suitable key pair, it is necessary for this electronic module to have a generator by means of which such a (suitable) key pair can be generated, or it must have an interface and a key memory so that an externally generated key pair can be written into the electronic module. In both cases, however, the electronic module must know the applicable/associated prerequisites and operations (e.g., encrypting with the private key).

It is provided that the electronic modules are each provided with a suitable key pair by the original manufacturer or a third party authorized by the original manufacturer during the production process or during a service use; furthermore, the public key of the suitable key pair is stored at the corresponding point in time in the list of electronic modules classified as trustworthy. During production or later, due to a module being exchanged or added, the field device is informed by a trustworthy person that the exchanged or added electronic module is to be considered trustworthy. In this case, the field device adopts the public key of the electronic module into its module trust list MTL.

When an electronic module is exchanged, the public key of the replaced electronic module is deleted from the list of electronic modules classified as trustworthy.

As already mentioned above, the check or the test as to whether the electronic module is authentic can be carried out during ongoing operation of the field device.

It has also already been mentioned that in connection with the present disclosure, instead of the public key of the electronic module, a derivation, e.g., a hash value, or some other independent and unique identification can be used.

### BRIEF DESCRIPTION OF THE DRAWINGS

The present disclosure is explained in greater detail with reference to the following figures. The following is shown:

FIG. 1 shows a schematic representation of a field device, which is suitable for carrying out the method according to the present disclosure, with a plurality of electronic modules, and

FIG. 2 shows a flowchart describing the method according to the present disclosure with different developments.

### DETAILED DESCRIPTION

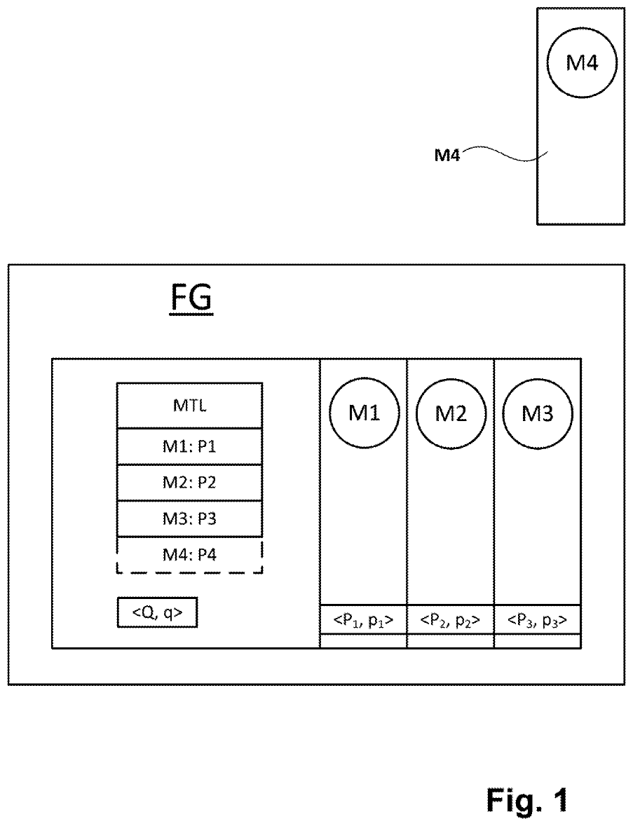

FIG. 1 shows a schematic representation of a field device FG which has a plurality of electronic modules Mk and which is suitable for carrying out the method according to the present disclosure. In the illustrated case, field device FG has three electronic modules Mk with k=1, 2, 3. Each electronic module Mk of the field device FG is assigned a suitable key pair Pk, pk with k=1, 2, 3. This suitable key pair Pk, pk is a prerequisite for the associated electronic module Mk being able to confirm its authenticity. Each key pair Pk, pk consists of a public key Pk and a private key pk. Furthermore, the public keys Pk of the suitable key pairs Pk, pk are stored in a list MTL, wherein the list MTL is assigned to the field device FG or a unit U communicating with the field device FG. MTL is the abbreviation for module trust list. The list contains the public keys Pk of the electronic modules Mk classified as trustworthy. Only when the checking steps according to the method according to the present disclosure and/or its further embodiments are positively rated, an exchanged or newly added electronic module Mk is functionally integrated into the field device FG.

A separate key pair Q, q consisting of public key Q and private key q is also assigned to the field device. The field device FG can, if necessary, transmit the public key Q to one or more electronic modules Mk in order, for example, to determine a secret knowledge between the field device FG and the electronic module Mk and to use this (or a derivation thereof) as a symmetric key for an encrypted communication (keyword: “Diffie Hellman,” exchange of public keys). It is also possible that not only the electronic module Mk has to prove its identity to the field device FG, but that the field device FG also has to prove its identity to the electronic module Mk. If an electronic module Mk has stored, for example, many sensitive (secret) data, it should possibly be able to communicate them only to one or only to specific field devices FG. For this purpose, each electronic module Mk would have to have a stored field device trust list in which the public keys of the field devices FGk classified as trustworthy are listed.

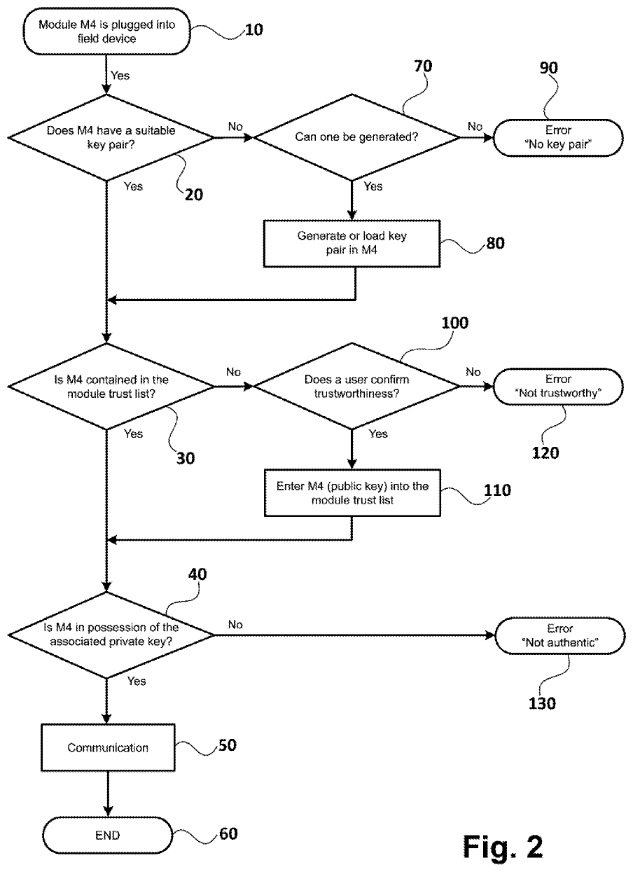

FIG. 2 shows a flowchart describing the method according to the present disclosure with different developments.

Below program point 10, a new electronic module Mk, e.g., Mod3new, is plugged in instead of electronic module Mod3, for example; alternatively, a new module Mk, e.g., the electronic module Mod4, is newly added. At program point 20, a check is made as to whether the new electronic module Mk has a suitable key pair Pk, pk. If this is the case, a check is made at program point 30 as to whether the public key Pk of the exchanged or added electronic module Mk is listed in the MTL list of public keys Pk. If the test is positive, a check is made at program point 40 as to whether the new electronic module Mk is in possession of the correct private key pk. If this check is positive, communication or interaction with the field device FG or some other electronic module Mk of the field device FG of the exchanged or added electronic module Mk concerning the functionality of the field device FG is permitted. The check is terminated at program point 60. It is also possible for the check to be carried out by a separate unit. This is not shown separately in FIG. 2.

In order to check whether the electronic module Mk is in possession of the public key Pk of the suitable key pair Pk, pk, which is determined at program point 30, the field device FG or the unit U communicating with the field device FG requests the public key Pk of the exchanged or added electronic module Mk and checks whether the public key Pk of the electronic module Mk is stored in the list MTL.

The check as to whether the electronic module Mk is also in possession of the correct private key pk of the suitable key pair Pk, pk (program point 40) is carried out by means of a challenge/response method. For this purpose, an arbitrary message m is sent to the exchanged or added electronic module Mk by the field device FG, as a challenge with the request for signature creation using the existing private key pk. The electronic module Mk signs the message m with its private key pk and returns the signature as a response. The signature is used to check whether the electronic module Mk is in possession of the correct private key pk of the suitable key pair Pk, pk. This is the case if the message m after encryption and decryption is again the message m.

Let us consider what happens if the checks at one of the program points 20, 30, or 40 yield a negative result.

If the check at program point 20 shows that the electronic module Mk has no suitable key pair Pk, pk, a check is made as to whether a key pair Pk, pk can be generated or provided for the electronic module Mk (program point 70). In the event that the key pair Pk, pk can be provided or generated by the field device FG or another electronic module Mk (program point 80), the key pair Pk, pk is transferred to the exchanged or added electronic module Mk. It is also possible that the exchanged or added module Mk itself generates a suitable key pair Pk, pk. For this purpose, it must have suitable technical prerequisites. The public key Pk is stored in the list MTL once an authorized person has confirmed the trustworthiness of the electronic module Mk.

In the event that the electronic module Mk does not have a suitable key pair Pk, pk or that no suitable key pair Pk, pk can be generated for the electronic module Mk (program point 70), the electronic module Mk remains excluded from communication. Optionally, an error message is generated that the electronic module Mk has no suitable key pair Pk, pk (program point 90).

If the public key Pk of the exchanged or added module Mk is not contained in the list MTL (program point 30) and an authorized user does not confirm the trustworthiness of the electronic module Mk, an error message is issued that the electronic module Mk is not trustworthy (program point 120). The field device FG does not integrate the exchanged or added module into the communication.

If the challenge/response test at program point 40 shows that the electronic module is not in possession of the correct private key pk, an error message is generated at program point 130 that electronic module Mk is not authentic.

The method according to the present disclosure makes it possible to reliably prove the correct identity of an electronic module Mk. Fake modules can be weeded out.

1. A method for checking the authenticity of electronic modules of a modular field device in automation technology,
wherein each electronic module of the field device is assigned a suitable key pair which confirms the identity of the electronic module, wherein each key pair consists of a public key and a private key, and wherein the public keys of the suitable key pairs are stored in a list, wherein the list is assigned to the field device or to a unit communicating with the field device, wherein the method comprises the following method steps:
when an electronic module is exchanged or added, the field device or the unit communicating with the field device checks:
whether the exchanged or added electronic module has a key pair, and whether the public key of the exchanged or added electronic module is listed in the list of public keys,
whether the electronic module is in possession of the correct private key communication or interaction of the exchanged or added electronic module with the field device or some other electronic module concerning the functionality of the field device is permitted if the check is concluded with a positive result.

2. The method of claim 1, comprising the following method step:
in order to check whether the electronic module is in possession of the public key of the suitable key pair, the field device or the unit communicating with the field device requests the public key of the exchanged or added electronic module and checks whether the public key of the electronic module is stored in the list.

3. The method of claim 1, comprising the following method step:
the test as to whether the electronic module is in possession of the private key of the suitable key pair is carried out by means of a challenge or response method.

4. The method of claim 3, comprising the following method steps:
an arbitrary message is sent to the exchanged or added electronic module by the field device, as a challenge with the request for signature creation using the private key;
the electronic module signs the message with its private key and returns the signature as a response;
the signature is used to check whether the electronic module (Mk) is in possession of the private key (pk) of the suitable key pair (Pk, pk).

5. The method of claim 1, comprising the following method step:
if the check shows that the exchanged or added electronic module has no key pair, a check is made as to whether a key pair or the electronic module can be generated or provided, wherein in the event that the key pair is provided or generated by another electronic module, the key pair is transferred to the exchanged or added electronic module.

6. The system of claim 5, comprising the following method step:
in the event that the electronic module has no suitable key pair or that no suitable key pair can be generated for the electronic module, the electronic module remains excluded from the communication.

7. The method of claim 1, comprising the following method steps:
if the check shows that the exchanged or added electronic module has a key pair, but that the public key of the key pair is not stored in the list, the public key of the generated key pair is assigned to the list if an authorized person confirms the trustworthiness of the electronic module.

8. The method of claim 1, comprising the following method steps:
in the event that a suitable key pair can be generated for the electronic module, the public key of the key pair is stored in the list if an authorized person confirms the trustworthiness of the electronic module.

9. The method of claim 1, comprising the following method steps:
the electronic modules are each provided with a suitable key pair by the original manufacturer or a third party authorized by the original manufacturer during the production process or during a service use, and
the public keys of the suitable key pairs are stored in the list.

10. The method of claim 1, comprising the following method step:
when an electronic module is exchanged, the public key of the replaced electronic module is deleted from the list.

11. The method of claim 1, comprising the following method step:
the check and the test are carried out during ongoing operation of the field device.

12. The method of claim 1, comprising the following method step:
instead of the public key of the electronic module a derivation is used.
